(19) United States
(12) Patent Application Publication
(10) Pub. No.: US 2006/0004605 A1
(43) Pub. Date: Jan. 5, 2006

(54) System and method for a comprehensive interactive graphical representation of a health care facility for managing patient care and health care facility resources

(75) Inventors: Daniel J. Donoghue, Oregon, WI (US); James Ferris, Madison, WI (US); Handy Patriawan, Madison, WI (US); Steven J. Larsen, Cross Plains, WI (US); Christopher C. Spotts, Madison, WI (US); Christopher J. Alban, Madison, WI (US)

Correspondence Address: GODFREY & KAHN S.C., 780 NORTH WATER STREET, MILWAUKEE, WI, 53202, US

(73) Assignee: Epic Systems Corporation

(21) Appl. No.: 11/075,614

(22) Filed: Mar. 9, 2005

Related U.S. Application Data
(60) Provisional application No. 60/581,866, filed on Jun. 21, 2004.

(51) Int. Cl. G06Q 10/00; G06Q 50/00

(52) U.S. Cl. 705/2; 705/1; 715/700

(57) ABSTRACT

A system and method for a comprehensive interactive graphical representation of a health care facility for managing patient care and health care facility resources. The system comprises an integrated enterprise health care information system including at least one data repository for storing data and at least one graphical user interface for accessing data. The graphical user interface comprises a display area for displaying a graphical representation of all areas of the at least one health care facility. The graphical representation is preferably an interactive map of the at least one health care facility stored in the data repository. Because the graphical representation of the at least one health care facility is integrated within the enterprise health care information system, it allows a user access patient data and health care facility resource data, perform actions on the displayed patients and health care facility resources, and manage patient care and health care facility resources.

### CROSS-REFERENCE TO RELATED APPLICATION

This application is based on and claims the benefit of U.S. Provisional Application No. 60/581,866, filed on Jun. 21, 2004, and incorporated herein by reference.

### BACKGROUND OF THE INVENTION

The present invention relates generally to health care management and health care facility resource management, and more particularly, to a system and method for a comprehensive interactive graphical representation of a health care facility for managing patient care and health care facility resources.

Health care facilities provide for patient care. To provide patient care, it is necessary to maintain many types of information for patients. Access to this information is typically provided through a variety of software applications, usually related to the type of service being performed. In addition to providing patient care, health care facilities must manage many aspects of patient care. For example, health care facilities must keep track of patient admissions, discharges and transfers, appointment and procedure scheduling, billing and insurance information, and patient location and status. To effectively manage all aspects of patient care, health care facilities currently use a wide variety of health care management systems. Traditional health care management systems include paper charts and manually updated display boards. Recent upgrades in health care management systems include electronic systems that store, display, and facilitate the management of patient data. Most of these systems display information in a tabular format, but some include a display formatted to show patient room or bed locations. One such electronic system is disclosed in U.S. Patent Publication No. 2003/0074222, published Apr. 17, 2003. However, this system is limited to managing patient bed assignments and bed occupancy levels in a health care facility.

There are several limitations associated with these centralized bed management systems. First, the tabular displays are not very intuitive, especially to users who are new to a health care facility or new to health care management systems. A display showing a graphical representation or a map of the health care facility is more intuitive and easier to use. The prior art electronic systems that do have the capability of showing patient room or bed locations are also limited. Typically, those systems do not show an accurate graphical representation or map of the actual health care facility, but instead show a generic graphical representation of a typical facility. Also, the prior art systems are not able to track patients through the health care facility. Another significant limitation of the prior art systems is the fact that users cannot perform health care management actions on patients from the graphical representation or map display, such as admitting, discharging and transferring patients, assigning medical treatment teams to patients, scheduling patient appointments, ordering patient medications, and entering patient demographic, billing or insurance information. These actions must typically be performed using one or more separate health care management software applications.

Given the limitations and problems associated with the prior art systems and methods described above, there exists a need for an improved health care management system that is able to display an accurate graphical representation of a health care facility for admitting, discharging and transferring patients, managing patient care, and managing health care facility resources by allowing users to perform health care management actions on patients and facilities without moving between separate software applications. The present invention provides improvements over the prior art systems and methods described above, and provides solutions to problems raised or not solved thereby.

### SUMMARY OF THE INVENTION

The present invention provides a system and method for providing a comprehensive interactive graphical representation of at least one health care facility. The system comprises a health care information system having at least one data repository for storing patient data and health care facility resource data, and at least one graphical user interface in communication with the at least one data repository. The graphical representation of the at least one health care facility is preferably stored in the health care information system and displayable by the graphical user interface for managing patient care and health care facility resources.

The graphical representation provides an interactive map of the at least one health care facility that can be used to manage patient care and health care facility resources effectively. The interactive map allows users to see a visual representation of any area of the health care facility down to the individual rooms, resources, beds and patients. The interactive map provides a more intuitive view of the health care facility that increases the efficiency of health care management. The interactive map is used to view patients and health care facility resources, and perform actions on the patients and health care facility resources.

The graphical representation is preferably an interactive map of a hospital or other inpatient facility, an outpatient facility, a clinic, a nursing home, an assisted living center, an emergency department of a health care facility, an intensive care unit of a health care facility, a surgical department of a health care facility, etc. The graphical representation is developed from actual facility blue prints and/or the actual physical layout of the facility. The health care information system preferably includes a map building tool for creating the graphical representation of the health care facility from facility blue prints and/or the actual physical layout of the facility.

The method of the present invention provides a comprehensive interactive graphical representation of a health care facility. The method comprises the steps of storing patient data and health care facility resource data in at least one data repository of a health care information system, displaying a graphical representation of the health care facility in real time on at least one graphical user interface of the health care information system, and managing patient care and health care facility resources from the graphical representation of the health care facility. The at least one graphical user interface is in communication with the at least one data repository.

The present invention has several advantages over prior art systems and methods. For example, the graphical representation of the present invention is more intuitive, allowing users to see the data they need in a more efficient manner. The more intuitive graphical representation also makes the interactive map system easier to learn and operate, especially for those who are new to a health care facility or new to the interactive map system. The fact that the graphical representation is a realistic one based on the facility blue prints or the actual physical layout of the facility instead of a generic graphical representation makes the system even more intuitive and efficient. Another advantage of the present invention is the ability to perform tasks or health care management actions directly from the interactive map, eliminating the need to switch to one or more separate systems. The present invention allows users to perform actions like, among others, updating patient status, admitting, transferring and discharging patients, assigning treatment teams to patients, ordering patient medications and patient procedures, and entering and updating patient demographic, billing and insurance information.

Various other features, objects, and advantages of the invention will be made apparent to those skilled in the art from the accompanying drawings and detailed description thereof

### BRIEF DESCRIPTION OF THE DRAWINGS

FIG. 1 is a block diagram of an enterprise health care information system in accordance with an embodiment of the present invention;

FIG. 2 is a graphical representation of a health care facility in accordance with an embodiment of the present invention;

FIG. 3 is a graphical representation of a floor plan of various areas of a floor of the health care facility of FIG. 2;

FIG. 4 is an enlarged graphical representation of a Med-Surg area of the floor plan of the health care facility of FIG. 3;

FIG. 5 is an enlarged graphical representation of an Intensive Care Unit of the floor plan of the health care facility of FIG. 3;

FIG. 6A is an enlarged graphical representation of a Cardiac Surgery Unit of the floor plan of the health care facility of FIG. 3 illustrating interactive map features and drag and drop operations of the present invention;

FIG. 6B is an enlarged graphical representation of the Cardiac Surgery Unit of the floor plan of the health care facility of FIG. 3 illustrating interactive map features and right click operations of the present invention;

FIG. 6C is an enlarged graphical representation of the Cardiac Surgery Unit of the floor plan of the health care facility of FIG. 3 illustrating interactive map features and dynamic tooltip operations of the present invention;

FIG. 7 is a graphical representation of an emergency department of a health care facility illustrating interactive map features and common menus in accordance with an embodiment of the present invention;

FIG. 8 is a graphical representation of an outpatient health care facility illustrating interactive map features and common menus in accordance with an embodiment of the present invention;

FIG. 9 is another graphical representation of an outpatient health care facility illustrating the use of customizable summary boxes to perform actions on patients in accordance with an embodiment of the present invention;

FIG. 10 is a graphical representation of an inpatient health care facility illustrating the use of drag and drop operations to perform actions on patients in accordance with an embodiment of the present invention;

FIG. 11 is a graphical representation of an area of a health care facility illustrating the use of common visual indicators and a statistics chart for providing status of patients and facilities in accordance with an embodiment of the present invention; and

FIG. 12 is a graphical representation of an area of a health care facility illustrating the concept of assigning more than one patient to a bed, termed “shadow beds,” in accordance with an embodiment of the present invention.

### DETAILED DESCRIPTION OF THE INVENTION

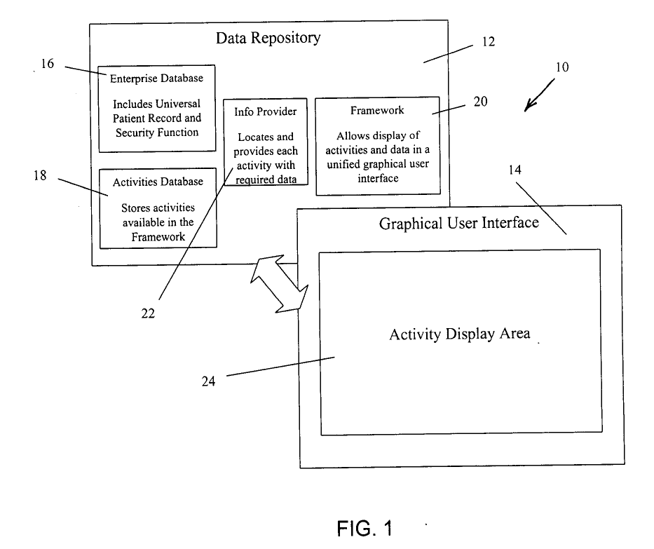

Referring now to the drawings, FIG. 1 is a block diagram of an enterprise health care information system 10 of the present invention. The enterprise health care information system 10 provides integration of health care records and health care records management, and facilitates access to health care records in a health care environment. The enterprise health care information system preferably comprises a plurality of integrated software applications and allows users to move between the plurality of software applications.

The integrated enterprise health care information system 10 preferably includes at least one data repository 12 for storing data and at least one graphical user interface 14 for accessing data. The data repository 12 is in communication with the graphical user interface 14. The data repository 12 preferably stores information related to system users and patients, including an enterprise database 16 with a universal patient record having data collected for each patient and security functions defining security parameters for system users, and an activities database 18. The universal patient record preferably includes information related to health care delivery for a patient, and information related to health care delivery management for the patient. System users have access to the universal patient record through one or more user interfaces in communication with the universal patient record. The security functions provide the ability to limit access to patient data displayable in the graphical representation of the health care facility and provide the ability to enable/disable actions performable on patients and health care facility resources displayable in the graphical representation of the health care facility. The data repository 12 further includes a modular framework 20 for supporting a plurality of patient care and health care facility resource management activities and an information provider 22 for providing each activity with its required data in communication with each other, and in communication with the enterprise database 16 and the activities database 18 which stores a plurality of activities for providing various aspects of patient care. These activities include, but are not limited to, activities used in providing health care to a patient and activities used in managing the health care provided to the patient.

The graphical user interface 14 provides a user access to the enterprise health care information system 10. The graphical user interface 14 displays information corresponding to one or more of the above-mentioned activities, and includes a common menu format for communicating available aspects in the graphical user interface, and common visual components for displaying information to the system user in an activity display area 24.

The enterprise health care information system 10 is designed to manage all aspects of a patient's health care including complete clinical, financial, and operational data relating to the patient through the use of the framework 20 for supporting a plurality of health care management activities that are stored in the activities database 18. Each health care management activity is preferably designed to manage a specific aspect of patient care. The framework 20 is preferably an integrated modular framework that allows users to easily move from one health care management activity to another using the information provider 22 in communication with the enterprise database 16 and the activities database 18.

In a preferred embodiment of the invention, the graphical user interface 14 comprises a display area 24 for displaying a graphical representation of at least one health care facility. The graphical representation is preferably an interactive map of the at least one health care facility stored in the data repository 12. Because the graphical representation of the at least one health care facility is integrated within the enterprise health care information system 10, it allows a user to visually locate patients and health care facility resources within the health care facility, provide access to patient data and health care facility resource data, perform actions on the displayed patients and health care facility resources, and manage patient care and health care facility resources.

The graphical representation preferably provides an interactive map of a health care facility. The interactive maps shown in the drawings are sample interactive maps developed to illustrate the features of the present invention. The interactive maps are preferably developed from actual facility blue prints or the actual physical layout of the health care facility to provide an accurate visual representation of the health care facility. The health care information system preferably includes a map building tool for creating the graphical representation of the health care facility from actual facility blue prints or the actual physical layout of the health care facility. The interactive maps provide an intuitive visual illustration of the health care facility, and are not limited to floor plans but are a realistic graphical representation of the health care facility. The interactive maps are preferably two-dimensional or three-dimensional graphical representations.

The present invention can display a graphical representation of an entire health care campus having a number of health care facilities or a single health care facility. A user can then select one building to see an interactive map of that health care facility down to the individual floors, rooms, resources, beds and patients. The graphical representation can be an interactive map of any health care facility, including but not limited to an inpatient facility, an outpatient facility, a hospital, an emergency department of a health care facility, an intensive care unit of a health care facility, a surgical department of a health care facility, a clinic, a nursing home, or an assisted living center. In addition, the graphical representation is preferably configurable and customizable based on the user's or facility's particular needs and preferences.

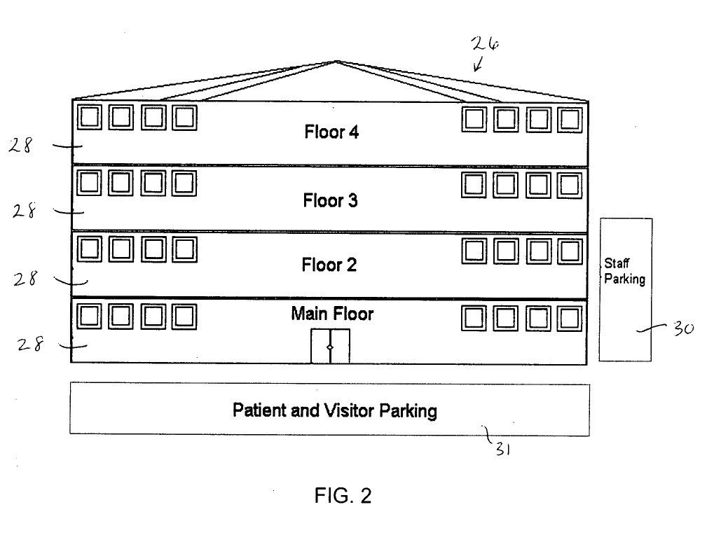

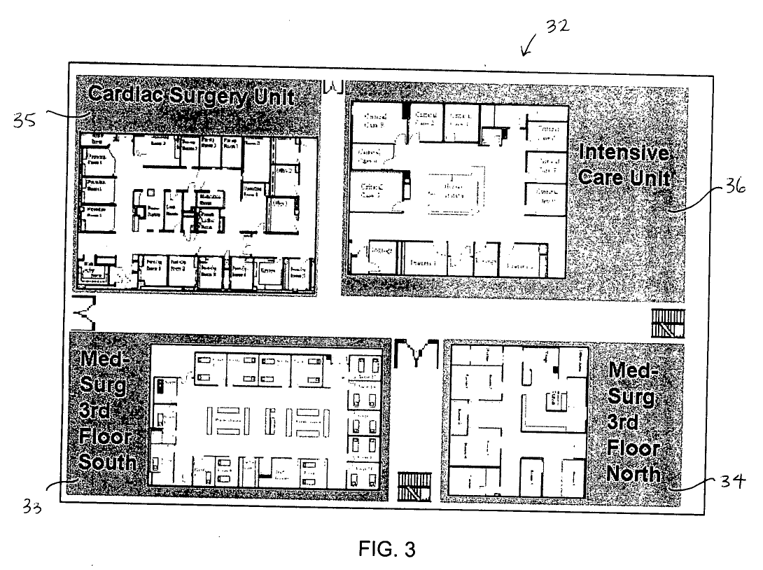

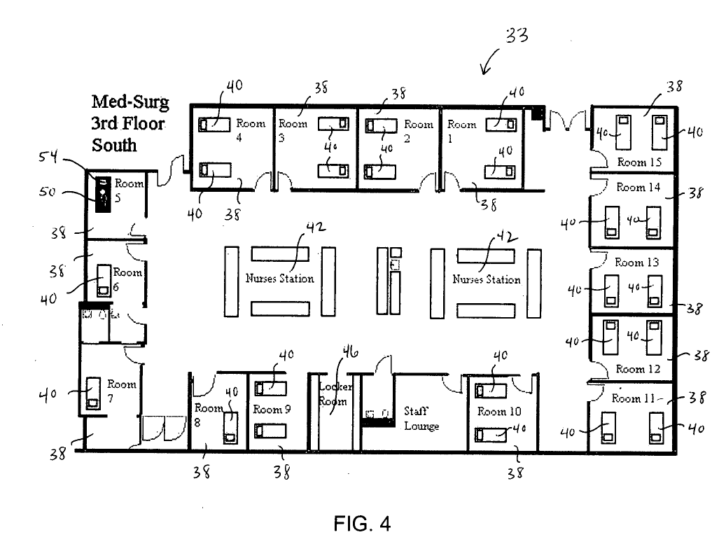

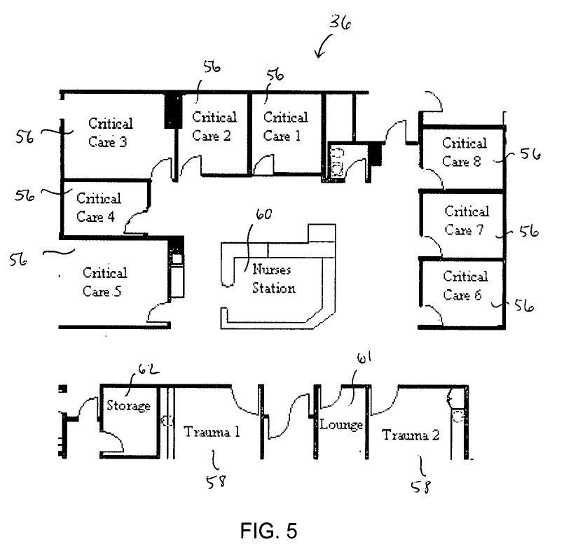

FIG. 2 is a graphical representation of a health care facility 26 in accordance with an embodiment of the present invention. FIG. 2 shows an overview of the health care facility 26 including all of the floors 28, the staff parking area 30, and the patient and visitor parking area 31. The graphical representation preferably displays the health care facility 26 including all areas of the facility down to the individual rooms, resources, beds and patients. The graphical representation, therefore, provides an interactive map with “drill down” capabilities. From the graphical representation shown in FIG. 2, a user can select a floor 28 of the health care facility 26 to display an interactive map of the selected floor, such as the third floor 32 shown in FIG. 3. A user can then select an area, department or unit on the selected floor to display an interactive map of the selected area, department or unit, such as the med-surg south unit 33 shown in FIG. 4 or the intensive care unit 36 shown in FIG. 5. From there, a user can select an individual room, patient or health care facility resource.

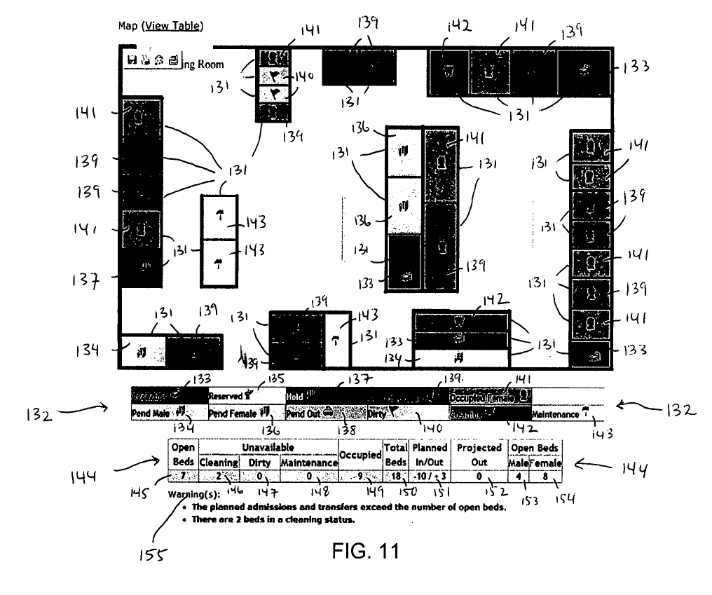

The health care information system preferably collects statistical data based on actions performed on patients and health care facility resources displayed in the graphical representation of the health care facility. The graphical representation preferably allows a user to display customizable statistics regarding different areas of the health care facility, display customizable statistics regarding patients in the health care facility, and display customizable statistics regarding health care facility resources of the health care facility. For example, the graphical representation also allows a user to selectively access, analyze and display bed occupancy data for the health care facility. The graphical representation also provides the ability to display patients having common characteristics or features, and display health care facility resources having common characteristics or features. The graphical representation further provides the ability to link or group patients having common characteristics or features and the ability to link or group health care facility resources having common characteristics or features. An example of a statistics chart is shown in FIG. 11.

The graphical representation can also preferably be used for tracking patients, health care facility resources, health care practitioners and patient charts through the health care facility, writing notes and documenting information on the graphical representation for input into patient data or charts, issuing alerts to health care practitioners and other users, directing patients and health care practitioners to their next locations, and seeing where patients have been in the health care facility, including all of the locations in the health care facility the patient has visited. The graphical representation preferably also provides the ability for electronic health record charting of patients, the ability for a user to document information about a patient or a health care facility resource by writing directly on the graphical representation through the use of a writable display, the ability to display a health care practitioner's schedule and the ability to display the locations of the scheduled appointments or patient visits in the health care facility.

The graphical representation of the present invention is preferably accessible via a web browser for connection to the Internet, an intranet, or other wireless network. For example, users can preferably log in from remote locations as well as in the health care facility. Further, the graphical representation may also include video from video cameras located throughout the health care facility. For example, patients in the ICU may be monitored using video cameras, thus the graphical representation could show a user the video recording of an ICU patient when a user selects an ICU patient on the graphical representation.

The graphical representation of the present invention may also be oriented with respect to the location of the user. For example, if a user logs in to a computer facing a south wall of the health care facility, the graphical representation will preferably display a map showing the south wall of the facility as the “top” or facing wall in the graphical representation, such that the user will automatically see what items shown on the map are currently in front of her, behind her, and to the left and right of her. In other words, the user will not have to first determine where she is located with respect to the map.

FIG. 3 is a graphical representation of an interactive map of the third floor of the health care facility of FIG. 2. The third floor 32 includes a med-surg south unit 33, a med-surg north unit 34, a cardiac surgery unit 35, and an intensive care unit 36. From here, a user can select one of these units or areas, or a specific room for further details on patients, health care facility resources or health care practitioners. Health care resources include all resources used in the health care facility, and health care practitioners include all practitioners that work in the health care facility or have any contact with the health care facility or patients in the health care facility, including but not limited to doctors, nurses, physician's assistants, technicians, dieticians, nutritionists, police officers, counselors, pharmacists, nurse practitioners, emergency medical services personnel, medical students, and members of a patient's treatment team. The graphical representation provides the ability to display patient and health care facility resource data, and allows a user to selectively access, analyze and display patient and health care facility resource data for the health care facility.

The graphical representation is preferably used for performing actions on patients and health care facility resources displayed in the graphical representation of the health care facility. For example, the graphical representation is preferably used for managing admissions, discharges and transfers of patients within the healthcare facility; admitting patients to the health care facility; assigning patients to rooms and beds of the health care facility; assigning treatment teams to patients; transferring patients within the health care facility; moving patients within the health care facility; swapping patients from one location to another in the health care facility; quarantining off an area for infection control; discharging patients from the health care facility; and locating and tracking patients, health care practitioners, health care facility resources, and patient charts through the health care facility, wherein each patient, health care practitioner, health care facility resource, and patient chart is identifiable by a tracking system, such as a global positioning system or a radio frequency identification system.

The graphical representation allows a user to perform actions on patients in the health care facility. The actions include but are not limited to admitting patients to the health care facility, assigning patients to rooms and beds of the health care facility, assigning treatment teams to patients, transferring patients within the health care facility, moving patients within the health care facility, swapping patients from one location to another in the health care facility, discharging patients from the health care facility, opening patient accounts, closing patient accounts, adding and updating patient demographic information, adding and updating patient insurance information, adding and updating patient billing information, assigning health care practitioners to patients, scheduling patient appointments, scheduling patient procedures, ordering patient medications, adding and updating patient status, opening and updating patient charts, etc.

The graphical representation also allows a user to perform actions on health care facility resources in the health care facility. The actions include but are not limited to assigning health care facility resources to beds of the health care facility, assigning health care facility resources to patients of the health care facility, assigning health care facility resources to rooms of the health care facility, moving health care facility resources within the health care facility, swapping health care facility resources from one location to another in the health care facility, etc.

The above actions are preferably performed using a number of different methods. For example, the actions are preferably performed by selecting an interactive icon on the graphical representation and selecting an action to be performed, by using a pointing device, by a drag and drop operation, by hovering over an area of the graphical representation, by a right click operation, or by a menu selection operation.

The graphical representation also provides the ability to cause further actions (behind the scenes functionality to trigger further actions) based on actions performed on the interactive map. For example, an action on an interactive map can initiate a notification to a health care practitioner that a patient needs assistance, a patient is ready to be seen, is ready for a procedure, is ready for a medication, is ready for a meal, etc. The notification is preferably in real-time, and can be an email notification, a pager notification, etc.

FIG. 4 is an enlarged graphical representation of a med-surg south unit 33 of the floor plan of the health care facility of FIG. 3. The interactive map of FIG. 4 shows a graphical representation of a plurality of patient rooms 38, patient beds 40 in the patient rooms 38, two nurses stations 42, a staff lounge 44, a locker room 46 and various layout details including hallways, exits, doorways and restrooms. Each interactive map is customized for each inpatient facility based on the actual facility layout of the facility and the users' preferences. This map shows a patient in the bed 40 of the patient room 38 labeled “Room 5,” as indicated by the patient icon 50 and the green/blue color code 54 shown in the patient bed 40. The patient icon 50 and the green/blue color code 54 are examples of visual indicators that can be included on the interactive map to represent certain identifiable and customizable characteristics or status indicators.

A user can preferably obtain information on this patient by selecting or hovering over the visual indicators or icons displayed in the interactive map. A user may also review patient data, review health care facility resource data, review the chart of the patient, review the status of the patient, perform actions on the patient, or perform actions on health care facility resources. A user could also determine if rooms were clean and available for new patients, or if rooms were dirty and not available for new patients. Visual indicators are preferably included to indicate empty beds, available beds, occupied beds, dirty beds, waiting patients, severity of patient condition such as low-priority, fast-track, and critical, patient age indications, such as pediatric, general, and geriatric, health care facility resources such as mobile and stationary diagnostic equipment, medication carts, and food service, etc. The displays are preferably configurable and customizable based upon the user's role, profile, login context, etc.

FIG. 5 is an enlarged graphical representation of the intensive care unit 36 on the third floor of the health care facility of FIG. 3. The graphical representation shows interactive maps of critical care areas 56 for critical care patients, trauma areas 58 for trauma patients, a nurse's station 60, a lounge 61, a storage area 62, and layout details such as hallways, doorways, and restrooms. The interactive map of the intensive care unit 36 is preferably developed from an actual facility blue print or an actual physical layout of the intensive care unit to provide an accurate visual representation of the intensive care unit. The interactive map of the intensive care unit is preferably customizable and configurable, based on the layout of the particular facility and the users' preferences.

The graphical representation provides the ability to display patients in the intensive care unit, display patients in rooms, display patients in beds, display a plurality of beds in a room, display a plurality of patients in a room, display a plurality of patients in a bed, and display patient data. The graphical representation allows a user to selectively access, analyze and display patient and health care facility resource data for the intensive care unit. Visual indicators, as described below, can also be used on the interactive map of FIG. 5. Visual alerts, such as flashing colors or icons, that function to alert users to critical or emergency situations, such as a crashing patient, can also be used on the interactive map. Video from video cameras located throughout the intensive care unit can also be included in the interactive map of the intensive care unit.

The graphical representation is preferably used for performing actions on patients and health care facility resources displayed in the graphical representation of the intensive care unit. For example, if a patient enters the intensive care unit after surgery, the interactive map can be used to admit the patient to the intensive care unit, assign the patient to a bed in the intensive care unit, order medications and procedures for the patient, assign treatment teams to the patient, view status of the patient, view monitor outputs connected to the patient, and record notes on the patient's chart. All other actions described herein preferably could also be performed using the interactive map of FIG. 5.

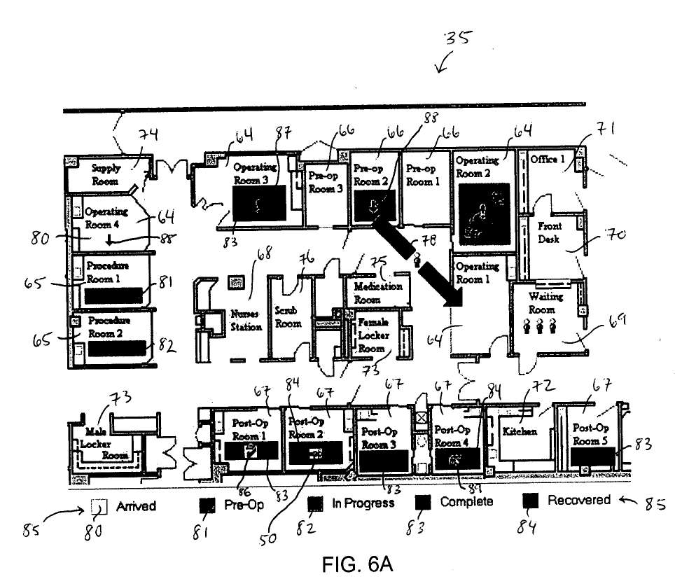

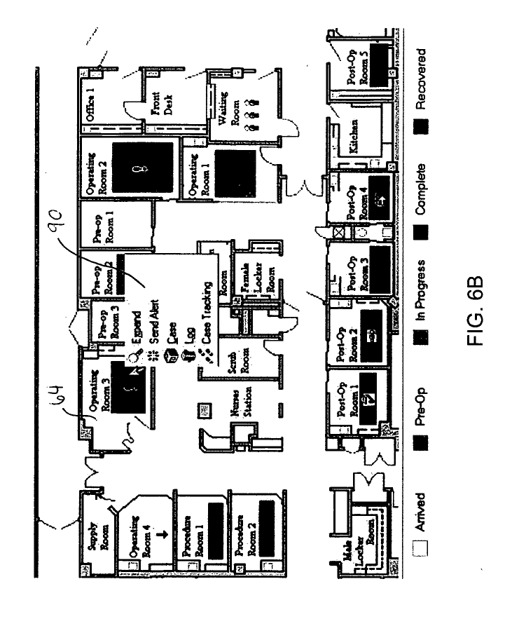

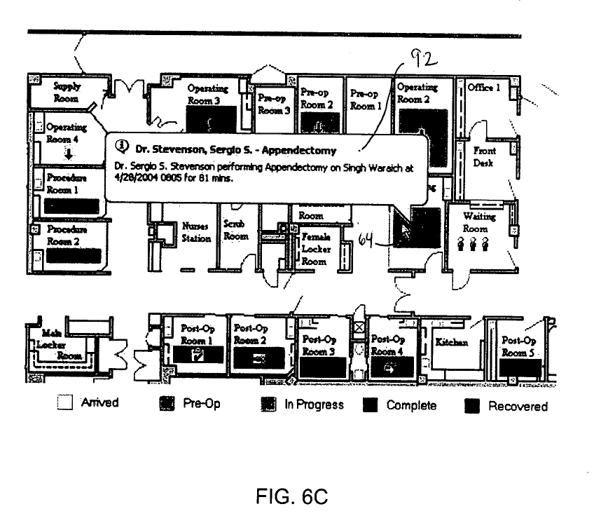

FIG. 6A is an enlarged graphical representation of a cardiac surgery unit 35 of the floor plan of the health care facility of FIG. 3 illustrating interactive map features and drag and drop operations of the present invention. The surgical facility includes a variety of different patient rooms, such as operating rooms 64, procedure rooms 65, pre-operating (pre-op) rooms 66, and post-operating (post-op) rooms 67. A nurses' station 68, a waiting area 69, a registration center 70, a doctor's office 71, a kitchen 72, locker rooms 73, a supply room 74, a medication room 75, and a scrub room 76. A drag and drop arrow 78 appears in FIG. 6A to illustrate the drag and drop operations supported by the present invention. In FIG. 6A, a patient is being transferred or moved from the pre-op room 66 labeled “Pre-op Room 2” to the operating room 64 labeled “Operating Room 1” using a drag and drop operation, as shown by drag and drop arrow 78. Other actions could also be performed using drag and drop operations.

The graphical representation preferably includes visual indicators to represent certain identifiable and customizable characteristics or status indicators. The visual indicators are preferably customizable icons and customizably color-coded. Various patient and other surgical facility statuses are indicated on the interactive map of FIG. 6A using visual indicators. For example, patients in patient rooms having an “Arrived” status are indicated on the interactive map using a yellow color code 80 inside the patient rooms as a visual indicator. Similarly, the green color code 81 indicates patients are in “Pre-op” status, the teal color code 82 indicates patients or patient rooms with surgeries or procedures “In Progress,” the blue color code 83 indicates patients or patient rooms with surgeries or procedures that are “Complete,” and the pink color code 84 indicates patients who are “Recovered.” A legend 85 associating the visual indicators with their respective patient statuses is also shown in FIG. 6A. Other types of visual indicators are also shown on the interactive map of FIG. 6A, including descriptive symbols or icons. For example, a patient icon 50 is used to indicate a patient is in a bed in a room and also to indicate patients are waiting in the waiting room, a chart icon 86 is used to indicate a patient surgery is complete, an exclamation point icon 87 is used to indicate a patient surgery is a high priority, a down arrow 88 is used to indicate a patient surgery is a low priority, and a luggage icon 89 is used to indicate a patient is recovered and ready to leave the surgical unit. Other icons could also be used to indicate a number of different patient statuses or characteristics. Visual indicators are preferably configurable and customizable based on the user's needs and preferences.

The visual indicators could preferably also used to identify or display a number of other characteristics or statuses. For example, the visual indicators could identify, without limitation: the confidentiality status of patients; patient gender, patient condition, and patient status; whether a treatment team has been assigned to a patient; the status of patients; the status of health care facility resources; rooms in use; clean rooms; dirty rooms; beds in use; clean beds; dirty beds; the location of patients that have outstanding orders; the location of patients that have overdue tasks; and the location of patients that have overdue medications. The visual indicators could display, without limitation: the status of different operating rooms; the type of procedure being performed in different operating rooms; the health care practitioners in different operating rooms; timing events related to the surgical procedure being performed, such as room-set up start, anesthesia induced, incision start, incision end, patient extubated, etc.; the patients in pre-op and the health care practitioners assigned for their care; the patients in post-op and the health care practitioners assigned for their care; and the patients in the post anesthesia care unit and the health care practitioners assigned for their care. Visual indicators could be used with any graphical representation of the present invention.

The graphical representation also preferably provides the ability to display visual alerts. The visual alerts include patient status alerts, and health care facility resource alerts. The visual alerts could also identify a number of other patient statuses, including without limitation, patients needing assistance, patients with a pushed call button, patients with outstanding orders, patients with overdue tasks, or patients with overdue medications.

The graphical representation further preferably provides the ability to display a health care practitioner's schedule and display the locations of scheduled operations in the surgical department. The graphical representation also preferably includes video from video cameras located through out the surgical department. The graphical representation is preferably also used to display the current stage and status of the surgical procedures being performed in the operating rooms.

Like all graphical representations according to the present invention, the interactive map of the surgical department is preferably developed from an actual facility blue print or an actual physical layout of the surgical department to provide an accurate visual representation of the surgical department. Further, the graphical representation preferably displays all areas of the surgical department down to the individual rooms, resources and patients.

The graphical representation is used for performing actions on patients and health care facility resources displayed in the graphical representation of the surgical department, and the graphical representation allows a user to perform actions on patients and health care facility resources in the surgical department. The actions could include, without limitation, assigning patients to rooms of the surgical department, scheduling rooms of the surgical department, ordering patient medications, moving patients to different locations within the surgical department, assigning health care facility resources to patients of the surgical department, assigning health care facility resources to rooms of the surgical department, moving health care facility resources to different locations within the surgical department, and swapping health care facility resources from one location to another in the surgical department. The graphical representation also preferably allows a user to selectively access, analyze and display patient and health care facility resource data for the surgical department.

FIG. 6B is an enlarged graphical representation of the cardiac surgery unit area of the floor plan of the health care facility of FIG. 3 illustrating interactive map features and right click operations of the present invention. The surgical facility interactive map in FIG. 6C shows an action box 90 that appeared when a user right clicked on the operating room 64 labeled “Operating Room 3.” The action box 90 shows an option for expanding the information displayed about the operating room or the patient in the operating room, such as accessing the patient's chart or accessing an information summary about the operating room. The action box 90 also shows options for sending an alert, accessing the case information for the surgical case being performed in the operating room, accessing an information log for the surgical case being performed in the operating room, and accessing a case tracking activity of the enterprise health information system. Right clicking is thus preferably one method by which a user can perform actions on a patient or health care facility resource in the health care facility. Right clicking could also produce an information summary box that does not provide options for performing actions but provides the user with information pertaining to the patient or health care facility resource clicked on. In addition, the graphical representation provides a dynamic, intelligent, real-time status of patients and health care facility resources. For example, right clicking on an empty bed would not offer the option of discharging, since there is no patient in the bed to discharge.

FIG. 6C is an enlarged graphical representation of the cardiac surgery unit area of the floor plan of the health care facility of FIG. 3 illustrating interactive map features and dynamic tooltip operations of the present invention. The graphical representation preferably displays a customizable information summary of a patient or health care facility resource on the graphical representation when a user selects or hovers over the patient or health care facility resource on the graphical representation. When a user hovers over a bed or an area on the map, a customizable summary information box 92 appears or pops up. Using tooltip operations, the information doesn't have to crowd the map by always being displayed, but it is always readily accessible. For example, the surgical facility interactive map in FIG. 6C shows a tooltip or customizable information summary box 92 that appears when a user selects a particular area on the interactive map. For example, the summary box 92 in FIG. 6C appeared when a user selected, preferably by hovering over, an operating room 64. The present invention can be configured to allow users to select any area on the interactive map, including but not limited to patients, patient rooms, patient beds, and patient waiting areas. Users can select areas on the interactive map in a number of ways, including but not limited to pointing device operations such as hovering over, single-clicking, double-clicking or right clicking a mouse or stylus pointer on the area the user wishes to select. A tooltip or summary box 92 preferably appears when a user hovers a pointing device over an area of the interactive map. The summary box 92 in FIG. 6C displays information about the surgical procedure or operation that is in progress in the selected operating room 64, including the doctor's name, the patient's name, the type of procedure in progress, the starting date and time of the procedure and the total number of minutes the procedure has been in progress. The information displayed in the summary box 92 is preferably configurable and customizable based upon the user's needs and the type of facility in the interactive map.

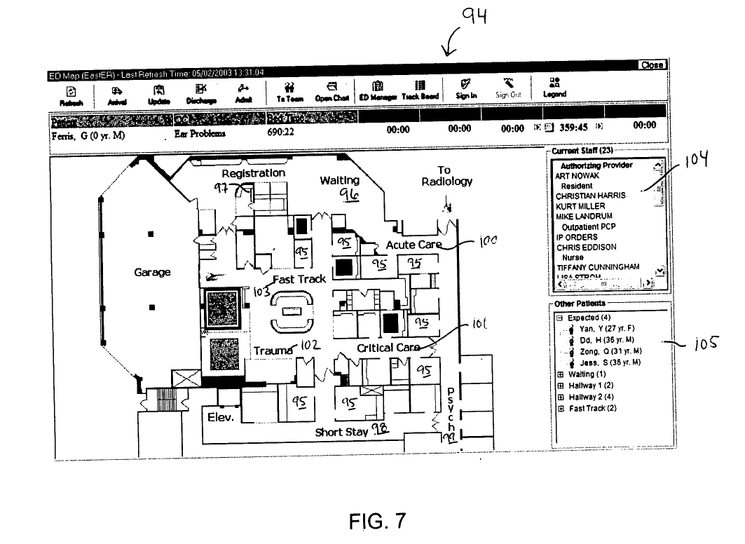

FIG. 7 is a graphical representation of an emergency department 94 of a health care facility illustrating interactive map features and common menus in accordance with an embodiment of the present invention. The graphical representation preferably displays all areas of the emergency department 94, such as examination areas, diagnostic areas, waiting areas, triage areas, employee areas, pharmacies, and virtual areas for patients en route to the emergency department. The graphical representation preferably provides the ability to display patients in rooms, display patients in beds, display a plurality of beds in a room, display a plurality of patients in a room, and display a plurality of patients in a bed.

The interactive map in FIG. 7 includes examination rooms 95, a patient waiting area 96, a registration center 97, a garage, and various types of treatment areas including an area for short stay patients 98, behavioral health patients 99, acute care patients 100, critical care patients 101, trauma patients 102, and fast track patients 103. The interactive map of FIG. 7 also shows layout details such as the location of stairs, elevators, and doors. The graphical representation preferably also provides the ability to display patients in the emergency department, including a plurality of patients in a room within the emergency department and a plurality of patients in a bed. Again, the interactive map is customizable and configurable based on the particular layout of the emergency department and the users' preferences, and is preferably developed from an actual facility blue print or an actual physical layout of the emergency department to provide a visual representation of the emergency department.

FIG. 7 also displays information about current staff in a first user window 104, and information about patients in a second user window 105. The first user window 104 preferably includes a list of staff or health care practitioners in a tabular format organized by type of health care practitioner, such as authorizing practitioner, resident, outpatient primary care physician (PCP), and nurse as shown. The second user window 105 preferably includes expandable lists of patients organized by type, such as expected patients, waiting patients, patients in hallway 1, patients in hallway 2, and fast track patients as shown. The interactive map could also show expected patients or other patients en route to the emergency department in virtual areas on the interactive map. A virtual area, for example, could be shown as a square area outside the emergency department, and expected patients could be listed or otherwise visually depicted in the square. The interactive map could be used for all of the purposes described above, including but not limited to admitting patients to the emergency department, transferring patients to another health care facility or another department such as the ICU, assigning a patient to a room or a bed, assigning treatment teams to patients, and discharging patients.

The graphical representation preferably allows a user to selectively access, analyze and display patient and health care facility resource data for the emergency department, and provides the ability to display patient and health care facility resource data. The graphical representation preferably also allows a user to perform actions on patients and health care facility resources in the emergency department. The actions include but are not limited to assigning patients to rooms and beds in the emergency department, assigning health care practitioners to patients, assigning treatment teams to patients, scheduling patient appointments, scheduling patient procedures, ordering patient medications, adding and updating patient status, assigning health care facility resources to the emergency department, and moving health care facility resources within the emergency department. The graphical representation further provides the ability for a user to document information about a patient or health care facility resource by writing directly on the graphical representation through the use of a writable display.

The graphical representation also preferably includes visual indicators to represent certain identifiable and customizable characteristics or status indicators. The visual indicators are preferably customizable icons and customizably color-coded. The visual indicators are preferably used to identify a number of patient characteristics or statuses. For instance, visual indicators could identify, without limitation: patient gender, patient condition, and patient status; whether a treatment team has been assigned to a patient; rooms in use; available rooms; rooms that need to be cleaned; waiting patients; the severity of a patient's condition; and health care facility resources and their location in the emergency department. The graphical representation further preferably provides the ability to display visual alerts.

Examples of uses of the interactive map of an emergency department include the following. A patient walks into an emergency room with a possibly sprained or broken wrist. A staff member at the registration desk uses the interactive map to admit the patient, enter the patient's chief complaints, enter the patient's identification, billing and insurance information if that information is not already in the enterprise health care information system, and assign the patient to the waiting area. The patient then shows on the interactive map in the list of waiting patients in the second scroll window 44. When an examination room is available, a user assigns the patient to the room and assigns a treatment team to the patient, both using the interactive map. A nurse on the treatment team then sees the patient. The nurse uses the interactive map to enter the patient's vitals and other information into the enterprise health care information system, and then uses the interactive map to alert a doctor or other treatment team member that the patient is now ready to be examined. Alerts could be issued using visual indicators on the interactive map, described in more detail below, or using a paging or email notification system in communication with the enterprise health care information system. The doctor then sees the patient and determines that the patient needs an x-ray for an accurate diagnosis. The interactive map can then be used to order the x-ray, transfer the patient to the radiology department for the x-ray, order any necessary medications for the patient, and make notes on the patient's chart.

In another example, there was just a multiple car accident on the highway. Emergency response personnel have alerted the emergency department that they are en route in an ambulance with three critical patients. An emergency department staff member adds the patients to the list of expected patients using the interactive map. And view patient data and vital signs of the patients. When the patients arrive, the interactive map is used to assign the patients to rooms and assign treatment teams to the patients. Once the patients are stabilized by the treatment teams, the interactive map is used to admit patients to the hospital, transfer the patients to other departments in the health care facility for further treatment, enter notes on the patients' charts, order additional procedures for the patients, bill the patients, and open and close the patients' accounts.

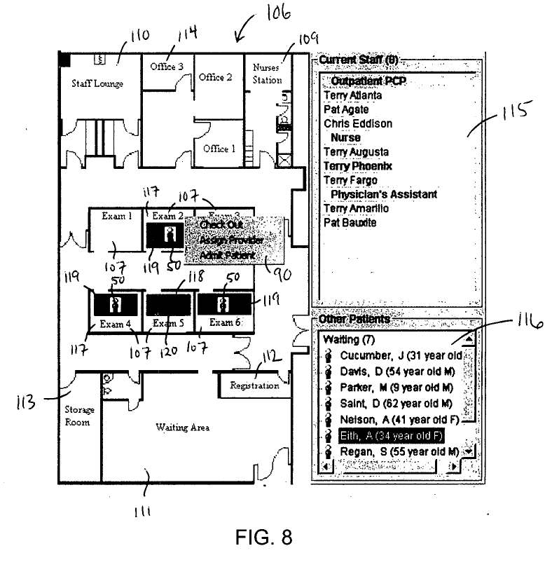

FIG. 8 is a graphical representation of an outpatient health care facility 106 illustrating interactive map features and common menus in accordance with an embodiment of the present invention. The graphical representation is preferably an interactive map of the outpatient facility 106 developed from an actual facility blue print or an actual physical layout of the outpatient facility to provide an accurate visual representation of the outpatient facility. The graphical representation preferably displays all areas of the outpatient facility 106 down to the individual rooms, resources and patients. The interactive map of FIG. 8 shows exam rooms 107, patient beds 108 in the exam rooms 107, a nurses station 109, a lounge 110, a waiting area 111, a registration center 112, a storage room 113, health care practitioner offices 114, a first user window 115 listing health care practitioners on staff, and a second user window 116 listing waiting patients. FIG. 8 also shows occupied exam rooms 117, unoccupied exam rooms, and patient rooms on hold or held patient rooms 118.

The graphical representation includes visual indicators to represent certain identifiable and customizable characteristics or status indicators. The visual indicators can preferably be used to identify, among other things, patient gender, patient condition, and patient status, rooms in use, patients waiting for a predetermined amount of time, and the length of time a patient has been waiting. In FIG. 8, for example, the occupied, unoccupied, and held status of the patient rooms is indicated using visual indicators. Occupied rooms are indicated with a red color code 119 and a patient icon 50, held rooms are indicated with a green color code 120, and unoccupied rooms appear empty. A number of other visual indicators can be used to indicate a number of other patient or facility statuses, as previously described. For example, patient icons could be shown in the waiting area 11 as well as in the second user window 116.

The graphical representation of FIG. 8 can preferably be used for performing actions on patients and health care facility resources displayed in the graphical representation of the outpatient facility, and the graphical representation allows a user to perform actions on patients and health care facility resources in the outpatient facility. The actions include but are not limited to checking-in patients to the outpatient facility, opening and closing patient accounts, adding and updating patient demographic information, adding and updating patient insurance, adding and updating patient billing information, indicating the collection of patient co-payments, scheduling patient appointments, assigning patients to rooms of the outpatient facility, assigning health care practitioners to patients, moving patients to different locations within the outpatient facility, assigning health care facility resources to rooms of the outpatient facility, moving health care facility resources to different locations within the outpatient facility, and swapping health care facility resources from one location to another in the outpatient facility.

The interactive map of FIG. 8 illustrates one method for performing health care management activity actions on patients. FIG. 8 shows an action box 90 displayed as a user selected occupied room 117 labeled “Exam 2.” As previously described, the present invention can preferably be configured to allow users to select any area on the interactive map, including but not limited to patients, patient rooms, patient beds, and patient waiting areas. Users can preferably select areas using a variety of selection methods, including but not limited to pointing device operations like mouse clicking, double mouse clicking, right mouse clicking, hovering a mouse pointer over the area to be selected, or using a stylus or other pointing device to select the area. Alternatively, the action box 90 appears when selecting a patient name from a user window, such as the second user window 116. In FIG. 8, the action box 90 appears when the area is selected, and provides choices of health care management activity actions to be performed on the patient. The displayed action choices in FIG. 8 are “Check Out” to discharge the patient, “Assign Practitioner” to assign a treatment team or individual health care practitioner to the patient, and “Admit Patient” to admit the patient to the outpatient facility. The action box 90 could be configured to include other choices as well, including all health care management activity actions described above, but is preferably configured to include only those choices that are relevant to the area selected or the health care facility displayed. For example, selecting an unoccupied room would preferably not include a choice to “Check Out” or discharge a patient because there is no patient to discharge. Thus, the graphical representation provides a dynamic, intelligent, real-time status of patients and health care facility resources.

The graphical representation preferably displays a customizable information summary of a patient or health care facility resource on the graphical representation when a user selects or hovers over the patient or health care facility resource on the graphical representation. The graphical representation further preferably provides the ability for a user to document information about a patient or health care facility resource by writing directly on the graphical representation through the use of a writable display, the ability to display a health care practitioner's schedule and display the locations of scheduled appointments or patient visits in the outpatient facility, the ability to send alerts to health care practitioners, and the ability to display the location of patients who are checked in for appointments. The graphical representation also preferably allows a user to selectively access, analyze and display patient and health care facility resource data for the outpatient facility. The graphical representation is preferably accessible via a web browser.

An example of how the interactive map is used in an outpatient facility or clinic is as follows. A patient has scheduled an appointment with her primary care physician for an annual physical exam. On the day of her exam, the patient appears on the interactive map of the clinic as an expected patient. When the patient arrives, the receptionist moves the patient from expected status to waiting status, and updates the patient's insurance information and reason for the visit, all using the interactive map. When the patient has been waiting for an hour, the interactive map issues an alert to the receptionist using visual indicators on the interactive map as described below. When an examination room in the clinic is available, the interactive map is used to assign the patient to the room and assign a treatment team to the patient. An alert is also issued at this time to the nurse on the treatment team to alert her to the fact that the patient is now in the room and awaiting a nurse. The alert could also be issued through a paging or email notification system in communication with the enterprise health care information system. The nurse sees the patient, and uses the interactive map to record the patient's vital information, and any other relevant information gathered during her visit with the patient. The nurse then uses the interactive map to alert the doctor on the treatment team to the fact that the patient is now ready to see the doctor. Again, alerts could be issued as visual indicators on the interactive map or through a paging or email notification system. The doctor then sees the patient, and decides the patient should have some blood work. The interactive map can be used to order the blood work procedures, as well as to make notes on the patient's chart and alert the nurse that the patient now needs blood work. When the exam is completed, the interactive map can then be used to discharge the patient from the clinic, schedule another appointment in the clinic or at another health care facility, and record any payment information for the visit, such as an insurance co-payment received by the clinic.

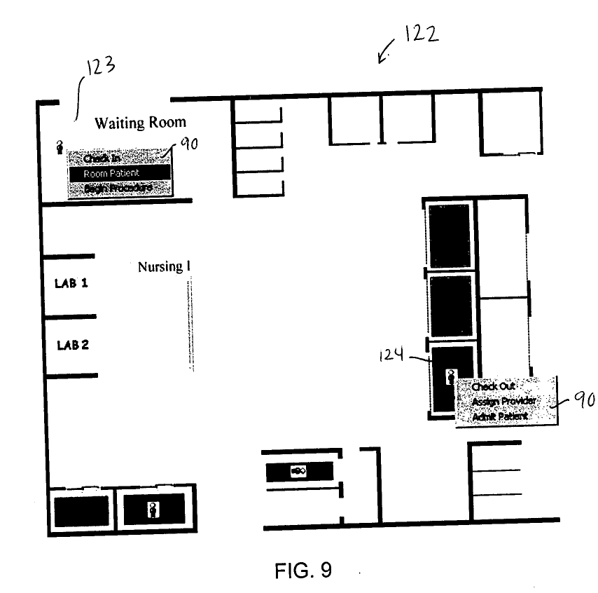

FIG. 9 is another graphical representation of another outpatient health care facility 122 illustrating the use of customizable action boxes to perform actions on patients in accordance with an embodiment of the present invention. The action box 90 shown as a user selected a patient in the waiting area 123 includes the choices “Check In” to check the patient in to the outpatient facility, “Room Patient” to assign a patient to a room, and “Update Billing Info” to update the patient's billing information, such as address and insurance practitioner information. Because the graphical representation can display the dynamic, intelligent, real-time status of patients and health care facility resources, the action box 90 shown as a user selected a patient in a patient room 124 includes different choices that are relevant to a patient in that area of the health care facility, such as “Check Out” to discharge the patient from the outpatient facility, “Assign Practitioner” to assign a health care practitioner to the patient, and “Admit Patient” to admit the patient to another health care facility for further treatment. Any of the actions previously described could be displayed in the action box 90 as actions to be performed, or the action box 90 could just be an information summary box displaying patient data or other information relevant to the patient or area of the interactive map selected. For instance, selecting the waiting area 123 could show a summary box including the number of patients waiting, and the length of time each patient has been waiting. Similarly, selecting a patient could show a summary box including patient status information such as patient gender, patient age, current condition and current medications. Further, instead of a summary box or an action box 90, selecting a patient or area on the interactive map could display a separate window providing choices of actions to be performed or providing other information relevant to the selected patient or area.

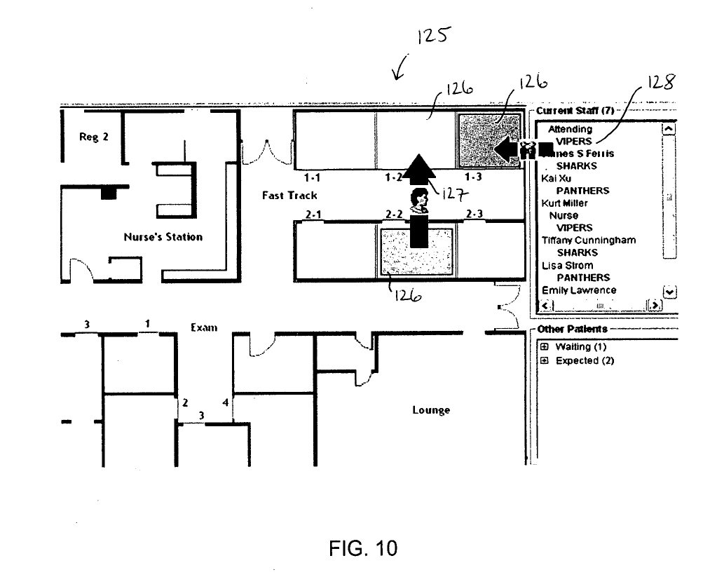

FIG. 10 is a graphical representation of an inpatient health care facility 125 illustrating the use of drag and drop operations to perform actions on patients in accordance with an embodiment of the present invention. For example, FIG. 10 shows a patient in an exam room 126 labeled “2-2” being transferred to another exam room 126 labeled “1-2” using a drag and drop operation between the exam rooms, as indicated by drag and drop arrow 127. FIG. 10 also shows a treatment team 128 labeled “Vipers” being assigned to a patient in an exam room 126 labeled “1-3” using a drag and drop operation between a first user window 129 and the exam room 126, as indicated by drag and drop arrow 130. To perform a drag and drop operation, the user selects the item to be dragged, such as the patient in the exam room 126 labeled “2-2” or the “Vipers” treatment team 128, and drags the item to the desired location, such as the exam room 126 labeled “1-2” or the patient in the exam room labeled “1-3.” In some cases, as is the case when transferring a patient from one room to another, the item being dragged is removed from its original location because the item cannot be in two locations at one time. In other cases, as is the case when assigning treatment teams, the dragged item is not removed from the original location because the item can be assigned to multiple locations at one time. Drag and drop operations can be used to perform all of the health care management activity actions previously described.

FIG. 11 is a graphical representation of an area of a health care facility illustrating the use of common visual indicators and a statistics chart for providing status of patients and facilities in accordance with an embodiment of the present invention. FIG. 11 uses both color-coded visual indicators and descriptive symbols or icons as visual indicators to represent certain identifiable characteristics or status indicators, though any differentiating visual indicators could be used. Preferably, the user can configure or customize the present invention to include the user's preferred visual indicators to represent the user's preferred status indicators. Visual indicators could be used in association with any number of status indicators, including but not limited to tracking the location of patients in the emergency department, identifying whether or not a treatment team has been assigned to a patient, identifying the status of patients/rooms/beds, identifying patient status such as gender, age and medical condition, identifying patient data such as vitals and other monitored information, determining which rooms/beds are in use, clean, or dirty, identifying the location of patients that have outstanding orders, or identifying the location of patients that have overdue tasks or medications. FIG. 11 includes patient rooms 131 and a legend 132 describing each visual indicator or set of visual indicators and the associated status. The legend 132 shows an available room 133 is represented by a dark green color code and an empty bed icon symbol, a male reserved room 134 is represented by a light blue color code and a “pending in” icon symbol to indicate that a room is reserved for an incoming male patient, a reserved room is represented by a white color code and a reserved icon symbol, a female reserved room 136 is represented by a light pink color code and a “pending in” symbol to indicate that a room is reserved for an incoming female patient, a held room 137 is represented by a dark blue and a hold icon symbol, a ready-for-discharge room 138 is represented by a gray and a “pending out” symbol to indicate that a patient is ready to be discharged, a male occupied room 139 is represented by a medium blue color code and a patient head icon symbol, a dirty room 140 is represented by a light brown or beige color code and a flag icon symbol to indicate that a room is dirty and in need of cleaning, a female occupied room 141 is represented by a dark pink color code and a patient head symbol, a cleaning-in-progress room 142 is represented by an orange color code and a butterfly icon symbol to indicate that a room is in the process of being cleaned, and a maintenance-needed room 143 is represented by a yellow color code and a hammer icon symbol to indicate that a room is in need of maintenance or being serviced by the maintenance crew. Any differentiating colors or symbols or other visual indicators could be used to alert users at a glance of the status of patient rooms. Preferably, however, color codes are not the only visual indicators used, as some users may be color blind and thus unable to distinguish between the color codes. The visual indicators could be used with other areas on the interactive map as well, and could be used to indicate other statuses on the interactive map. For example, a visual indicator could be used to indicate that a nurse has seen the patient and the patient is now waiting for a doctor, or visual indicators could be used to indicate which patients are in need of diagnostic services. Visual indicators could also indicate filtered information on the interactive map, for example, a user could request that the interactive map show all patients having pneumonia. Visual alerts could also be used in the graphical representation to highlight rooms based on configurable and customizable criteria, such as predetermined waiting times, wherein visual alerts would highlight patients in the waiting room that have been waiting for a predetermined amount of time, or patient condition, wherein a blinking icon or color-code in a patient room would indicate that the patient needs immediate attention.

FIG. 11 also shows a statistics chart 144 displayed in connection with the interactive map. The statistics chart 144 in FIG. 11 is used to manage bed occupancy levels, and shows the number of open beds 145, the number of beds unavailable due to cleaning status 146, dirty status 147 and maintenance status 148, the number of occupied beds 149, the total number of beds 150, the total number of patients planned in and out of the health care facility 151, the number of patients projected to be discharged from the health care facility 152, and the number of open beds for males 153 and females 154. Any patient data available in the enterprise health care information system 10 could be displayed in a statistics chart similar to that shown in FIG. 11. For example, a statistics chart could show how many patients are admitted with a particular ailment, such as chest pains, how many patients are currently waiting to see a doctor, or how many patients having a particular health insurance coverage are admitted to the health care facility. Warnings 155 could also be shown on the interactive map, for example, FIG. 11 shows warnings regarding the number of planned admissions versus the number of open beds, and regarding the number of beds in cleaning status.

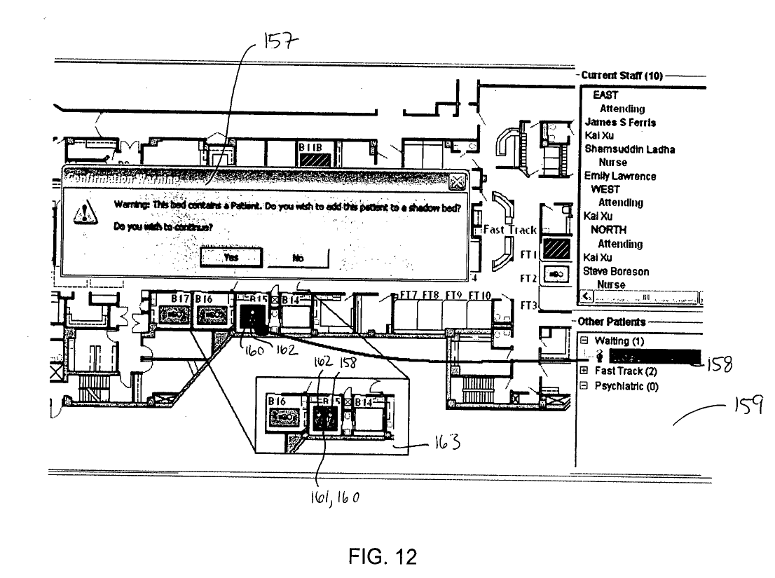

FIG. 12 is a graphical representation of an area of a health care facility illustrating the concept of assigning more than one patient to a bed, termed “shadow beds,” in accordance with the present invention. FIG. 12 illustrates the capability of the present invention to allow two or more patients to be assigned to a single bed. At times, a health care facility must assign multiple patients to a single room or bed because there are no more open or available beds in the health care facility and all the patients need to be treated immediately or multiple members of a family were injured in an accident, such as in an emergency room scenario. Another example of a “shadow bed” scenario is when a patient is being discharged and a new patient is assigned to the same bed. The present invention accommodates this “shadow bed” capability in the interactive map by allowing a plurality of patients to be assigned to a single bed. Preferably, the interactive map creates a copy or copies of the existing bed and assigns the extra patients to the same bed, which is preferably indicated on the interactive map as shown. FIG. 12 shows a question box 157 that appeared when a user attempted to assign waiting patient 158 labeled “Zorbaz” shown in a user window 159 to a bed 160 that already contained a patient 162. The question box 157 asks the user if she would like to add the patient to a shadow bed 161. If so, the user can simply select yes to assign the second patient 158 to the same bed 160. The interactive map will then display the two patients 158, 162 in the bed 160, which would then be a shadow bed 161, as shown in the highlighted section 163 of the interactive map in FIG. 12. Other visual indicators could also be used to indicate the presence of two or more patients in a single bed. If the user does not want to add the patient to a shadow bed 161, the user can select no in the question box 157 and then find another open bed for the patient. Other methods for creating shadow beds 161 could also be employed. Preferably, a user will see that a room has shadow beds when selecting the room for any reason. For example, if a user hovers a mouse over a room to get information about the patient(s) in the room, the user would preferably see information in a summary box 92 about all the patients in the room including those in shadow beds.

The present invention also allows users to swap patient bed assignments. For instance, Patient 1 may be in Room A that supports a particular piece of equipment that Patient 1 does not need, and Patient 2 may need the equipment but be in Room B that does not support it. The present invention allows a user to swap the patients' room assignments without first having to discharge both patients and then reassign them. In this case, Patient 1 would be swapped with Patient 2 so that Patient 2 would be in Room A with the necessary equipment and Patient 1 would be in Room B. One way in which the present invention could facilitate the swapping of patient room assignments is by providing an action choice in an information or summary box for swapping the patients. Thus, a user could select Patient 1, causing a summary box to appear, and then select the swapping option on the summary box. Selecting the swapping option would then prompt the user to identify Patient 2 as the patient with which to swap Patient 1.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. A system for providing a comprehensive interactive graphical representation of a health care facility comprising:
a health care information system having at least one data repository for storing patient data and health care facility resource data, and at least one graphical user interface in communication with the at least one data repository; and
a graphical representation of at least one health care facility stored in the health care information system and displayable by the graphical user interface for managing patient care and health care facility resources.

2. The system of claim 1, wherein the health care information system comprises a plurality of integrated software applications and allows users to move between the plurality of software applications.

3. The system of claim 1, wherein the data repository comprises a framework for supporting a plurality of patient care and health care facility resource management activities, an enterprise database for storing a universal patient record and security functions, an activities database for storing the activities available in the framework, and an information provider for providing each activity with its required data.

4. The system of claim 3, wherein the security functions provide the ability to limit access to patient data displayable in the graphical representation of the health care facility.

5. The system of claim 3, wherein the security functions provide the ability to enable/disable actions performable on patients and health care facility resources displayable in the graphical representation of the health care facility.

6. The system of claim 1, wherein the graphical user interface comprises a display area for displaying an interactive map of the health care facility.

7. The system of claim 1, wherein the graphical representation is an interactive map of the health care facility developed from an actual facility blue print or an actual physical layout of the health care facility to provide an accurate visual representation of the health care facility.

8. The system of claim 1, wherein the graphical representation is customizable by end users.

9. The system of claim 1, wherein the graphical representation is configurable by system administrators.

10. The system of claim 1, wherein the graphical representation displays each health care facility including all areas of the facility down to the individual rooms, resources, beds and patients.

11. The system of claim 1, wherein the graphical representation provides the ability to display patients and beds in rooms.

12. The system of claim 1, wherein the graphical representation provides the ability to display patients in beds.

13. The system of claim 1, wherein the graphical representation provides the ability to display patient data.

14. The system of claim 1, wherein the graphical representation provides the ability to display health care facility resource data.

15. The system of claim 1, wherein the graphical representation is used for performing actions on patients in the health care facility.

16. The system of claim 15, wherein the actions include at least one of admitting, transferring and discharging patients in the health care facility.

17. The system of claim 15, wherein the actions include moving patients within the health care facility.

18. The system of claim 15, wherein the actions include assigning patients to rooms and beds in the health care facility.

19. The system of claim 15, wherein the actions include managing patient accounts.

20. The system of claim 15, wherein the actions include adding and updating patient demographic, insurance and billing information.

21. The system of claim 15, wherein the actions include assigning health care practitioners to patients in the health care facility.

22. The system of claim 15, wherein the actions include scheduling patient appointments and patient procedures.

23. The system of claim 15, wherein the actions include ordering patient medications.

24. The system of claim 15, wherein the actions include adding and updating patient status.

25. The system of claim 15, wherein the actions include opening and updating patient charts.

26. The system of claim 1, wherein the graphical representation is used for performing actions on health care facility resources in the health care facility.

27. The system of claim 26, wherein the actions include assigning health care facility resources to rooms, beds and patients of the health care facility.

28. The system of claim 26, wherein the actions include moving health care facility resources within the health care facility.

29. The system of claim 1, wherein the graphical representation provides a dynamic, intelligent status of patients and health care facility resources.

30. The system of claim 1, wherein the graphical representation provides a real-time status of patients and health care facility resources.

31. The system of claim 1, wherein the graphical representation is an interactive map of an inpatient facility.

32. The system of claim 1, wherein the graphical representation is an interactive map of an outpatient facility.

33. The system of claim 1, wherein the graphical representation is an interactive map of an area, department or unit of a health care facility.

34. The system of claim 1, wherein the graphical representation allows a user to selectively access, analyze and display patient data for the health care facility.

35. The system of claim 1, wherein the graphical representation allows a user to selectively access, analyze and display health care facility resource data for the health care facility.

36. The system of claim 1, wherein the graphical representation allows a user to selectively access, analyze and display bed occupancy data for the health care facility.

37. The system of claim 1, wherein the health care information system collects statistical data based on actions performed on patients and health care facility resources displayed in the graphical representation of the health care facility.

38. The system of claim 1, wherein the graphical representation allows a user to display customizable statistics regarding different areas of the health care facility.

39. The system of claim 1, wherein the graphical representation allows a user to display customizable statistics regarding patients in the health care facility.

40. The system of claim 1, wherein the graphical representation allows a user to display customizable statistics regarding health care facility resources of the health care facility.

41. The system of claim 1, wherein the graphical representation provides the ability for electronic health record charting of patients.

42. The system of claim 1, wherein the graphical representation provides the ability to initiate notification of health care practitioners.

43. The system of claim 42, wherein the notification is in real-time.

44. The system of claim 1, wherein the graphical representation provides the ability for a user to document information about a patient by writing directly on the graphical representation through the use of a writable display.

45. The system of claim 1, wherein the graphical representation displays a customizable information summary of a patient or a health care facility resource on the graphical representation when a user selects or hovers over the patient on the graphical representation.

46. The system of claim 1, wherein the graphical representation includes visual indicators to represent certain identifiable and customizable characteristics or status indicators.

47. The system of claim 46, wherein the visual indicators are used to identify the confidentiality status of patients.

48. The system of claim 46, wherein the visual indicators are used to identify at least one of patient gender, patient condition and patient status.

49. The system of claim 46, wherein the visual indicators are used to identify whether a health care practitioner has been assigned to a patient.

50. The system of claim 46, wherein the visual indicators are used to identify the status of health care facility resources in the health care facility.

51. The system of claim 46, wherein the visual indicators are used to identify rooms and beds in use.

52. The system of claim 46, wherein the visual indicators are used to identify clean rooms and dirty rooms.

53. The system of claim 46, wherein the visual indicators are used to identify clean beds and dirty beds.

54. The system of claim 46, wherein the visual indicators are used to identify the location of patients that have outstanding orders or overdue tasks.

55. The system of claim 1, wherein the graphical representation provides the ability to display visual alerts.

56. The system of claim 55, wherein the visual alerts include patient status alerts.

57. The system of claim 55, wherein the visual alerts identify patients with a pushed call button.

58. The system of claim 55, wherein the visual alerts identify patients with at least one of outstanding orders and overdue tasks.

59. The system of claim 55, wherein the visual alerts include health care facility resource alerts.

60. The system of claim 1, wherein the graphical representation is accessible via a web browser.

61. The system of claim 1, wherein the graphical representation includes video from video cameras located through out the health care facility.

62. The system of claim 1, wherein the graphical representation provides the ability to display a health care practitioner's schedule and display the locations of scheduled tasks.

63. The system of claim 1, wherein the graphical representation provides the ability to display patients and health care facility resources having common characteristics or features.

64. The system of claim 1, wherein the graphical representation provides the ability to link or group patients and health care facility resources having common characteristics or features.

65. A comprehensive interactive graphical representation system for an emergency department of a health care facility comprising:
a health care information system having at least one data repository for storing patient data and health care facility resource data, and at least one graphical user interface in communication with the at least one data repository; and
a graphical representation of the emergency department of the health care facility stored in the health care information system and displayable by the graphical user interface for managing patient care and health care facility resources.

66. A comprehensive interactive graphical representation system for an intensive care unit of a health care facility comprising:
a health care information system having at least one data repository for storing patient data and health care facility resource data, and at least one graphical user interface in communication with the at least one data repository; and
a graphical representation of the intensive care unit of the health care facility stored in the health care information system and displayable by the graphical user interface for managing patient care and health care facility resources.

67. A comprehensive interactive graphical representation system of an outpatient facility comprising:
a health care information system having at least one data repository for storing patient data and outpatient facility resource data, and at least one graphical user interface in communication with the at least one data repository; and
a graphical representation of the outpatient facility stored in the health care information system and displayable by the graphical user interface for managing patient care and health care facility resources.

68. A comprehensive interactive graphical representation system for a surgical department of a health care facility comprising:
a health care information system having at least one data repository for storing patient data and health care facility resource data, and at least one graphical user interface in communication with the at least one data repository; and
a graphical representation of the surgical department of the health care facility stored in the health care information system and displayable by the graphical user interface for managing patient care and health care facility resources.

69. A method of providing a comprehensive interactive graphical representation of a health care facility, the method comprising the steps of:
storing patient data and health care facility resource data in at least one data repository of a health care information system;
displaying a graphical representation of the health care facility in real time on at least one graphical user interface of the health care information system, the at least one graphical user interface being in communication with the at least one data repository; and
managing patient care and health care facility resources from the graphical representation of the health care facility.

70. The method of claim 69, wherein the health care information system comprises a plurality of integrated software applications and allows users to move between the plurality of software applications.

71. The method of claim 69, wherein the data repository comprises a framework for supporting a plurality of patient care and health care facility resource management activities, an enterprise database for storing a universal patient record and security functions, an activities database for storing the activities available in the framework, and an information provider for providing each activity with its required data.

72. The method of claim 71, wherein the security functions provide the ability to limit access to patient data displayable in the graphical representation of the health care facility.

73. The method of claim 71, wherein the security functions provide the ability to enable/disable actions performable on patients and health care facility resources displayable in the graphical representation of the health care facility.

74. The method of claim 69, wherein the graphical user interface comprises a display area for displaying an interactive map of the health care facility.

75. The method of claim 69, wherein the graphical representation is an interactive map of the health care facility developed from an actual facility blue print or an actual physical layout of the health care facility to provide an accurate visual representation of the health care facility.

76. The method of claim 69, wherein the graphical representation allows a user to perform actions on patients in the health care facility.

77. The method of claim 69, wherein the graphical representation allows a user to perform actions on health care facility resources in the health care facility.

78. The method of claim 69, wherein the graphical representation is used for managing at least one of admissions, discharges and transfers of patients within the healthcare facility.

79. The method of claim 69, wherein the graphical representation provides the ability for electronic health record charting of patients.

80. The method of claim 69, wherein the graphical representation displays a customizable information summary of a health care facility resource on the graphical representation when a user selects or hovers over the health care facility resource on the graphical representation.

81. The method of claim 69, wherein the graphical representation includes visual indicators to represent certain identifiable and customizable characteristics or status indicators.

82. The method of claim 69, wherein the graphical representation provides the ability to display visual alerts.

83. The method of claim 69, wherein the graphical representation is accessible via a web browser.

84. The method of claim 69, wherein the graphical representation provides the ability to display patients having common characteristics or features.
